(19) United States
(12) Patent Application Publication
(10) Pub. No.: US 2011/0216235 A1
(43) Pub. Date: Sep. 8, 2011

(54) Electronic Mirror

(76) Inventor: Steven D. Waite, Pueblo West, CO (US)

(21) Appl. No.: 12/715,697

(22) Filed: Mar. 2, 2010

(51) Int. Cl. H04N 5/222

(52) U.S. Cl. 348/333.11; 348/E05.022

(57) ABSTRACT

The present invention is directed to an electronic mirror designed to replace a pocket or purse mirror. The electronic mirror has a housing with an electronic display. The electronic mirror includes a processor driving the display. An image sensor is connected to the processor by an electronic cord. The electronic cord is held in place by a retraction mechanism. In use the owner can pull out the image sensor to view the back, top and sides of their head. The electronic mirror includes a freeze frame feature and zoom feature. The electronic mirror also includes a stand to free up a user's hands.

### BACKGROUND OF THE INVENTION

It is quite common for people to carry pocket mirrors in their purse to check their hair and makeup. Often these pocket mirrors are in a case that may contain a light or makeup. While these mirrors are convenient they have several limitations. For instance, a pocket mirror is not useful for looking at the hair on the back of the head. In addition, a pocket mirror has no way to magnify an image.

Thus there exists a need for a mirror that allows the user to check the back of their head and to magnify areas that are hard to see.

### BRIEF SUMMARY OF INVENTION

An electronic mirror that overcomes these and other problems has an essentially rectangular housing having a front face and a back face. An electronic display attached to a front face of the housing. An electronic circuit is inside the housing. A battery is inside the housing. A number of buttons are attached to the front face of the essentially rectangular housing. An electronic cord has a first end and a second end. The first end is attached to the housing and is in electrical communication with the electronic circuit. An image sensor is attached to a second end of the electronic cord.

This electronic mirror fits in a women's purse and allows the owner to move the image sensor around to see the side and back of their head. It also includes a freeze frame feature and a zoom feature.

### BRIEF DESCRIPTION OF THE SEVERAL VIEWS OF THE DRAWINGS

FIG. 1 is a top right front perspective view of an electronic mirror in accordance with one embodiment of the invention;

FIG. 2 is a top left front perspective view of an electronic mirror in accordance with one embodiment of the invention;

FIG. 3 is a back view of an electronic mirror in accordance with one embodiment of the invention;

FIG. 4 is a side perspective view of an electronic mirror in accordance with one embodiment of the invention;

FIG. 5 is an exploded perspective view of an electronic mirror in accordance with one embodiment of the invention; and

FIG. 6 is a top right front perspective view of an electronic mirror with the image sensor extended in accordance with one embodiment of the invention

### DETAILED DESCRIPTION OF THE INVENTION

The present invention is directed to an electronic mirror designed to replace a pocket or purse mirror. The electronic mirror has a housing with an electronic display. The electronic mirror includes a processor driving the display. An image sensor is connected to the processor by an electronic cord. The electronic cord is held in place by a retraction mechanism. In use the owner can pull out the image sensor to view the back, top and sides of their head. In one embodiment, the electronic mirror includes a freeze frame feature and zoom feature. The electronic mirror solves the limitations associated with a standard handheld mirror.

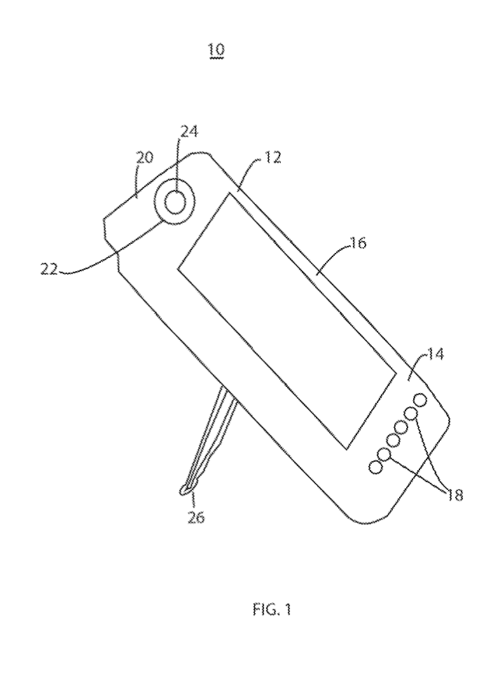

FIG. 1 is a top right front perspective view of an electronic mirror 10 in accordance with one embodiment of the invention. The electronic mirror 10 has an essentially rectangular housing 12. The housing 12 has a front face 14 that has an electronic display 16 and a plurality of buttons 18. An electronic image sensor 20 fits in a notch 22 in the housing 12. The electronic image sensor 20 has a fixed lens 24. In one embodiment, the electronic image sensor has a multi-focal lens 24. A stand 26 is pivotally attached to the housing 12. In another embodiment, the electronic mirror indudes a light as part of the image sensor. This allows the owner to use the mirror in low light situation.

Note that the same reference numerals will be used for the same elements through out the description.

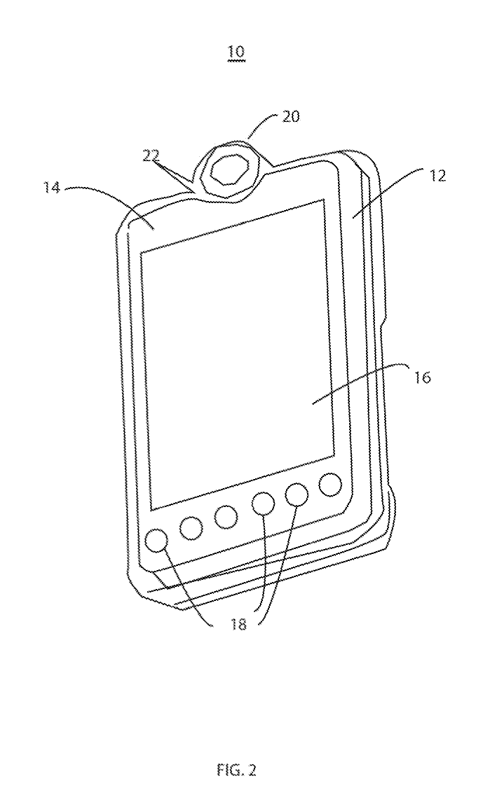

FIG. 2 is a top left front perspective view of an electronic mirror 10 in accordance with one embodiment of the invention. The electronic mirror 10 has a housing 12 with a front face 14 that has an electronic screen 16 that is a color screen in one embodiment. A plurality of buttons 18 are also located on the front face 14 of the housing 12. An image sensor 20 fits into a slot 22 of the housing 12.

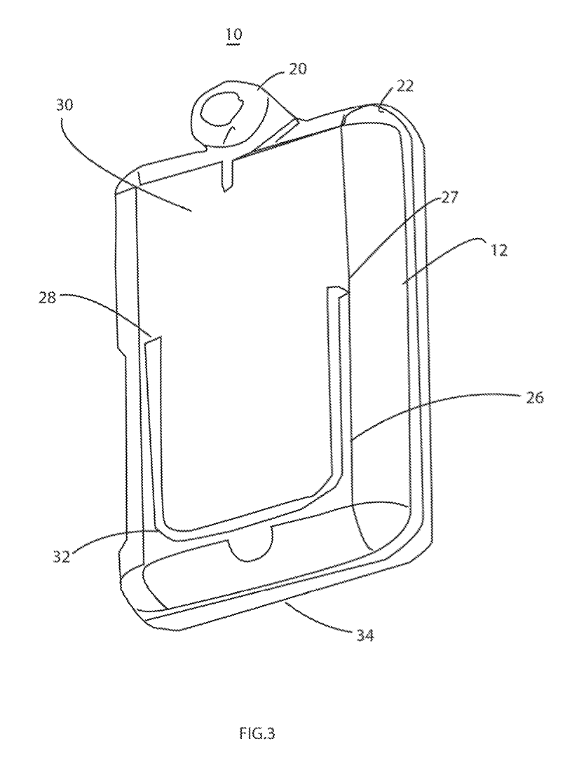

FIG. 3 is a back view of an electronic mirror 10 in accordance with one embodiment of the invention. In this view there is shown a stand 26 that is pivotally attached 28 to the housing 12. In one embodiment, the stand 26 is a metal wire and the ends fit is slots that allows the stand 26 to pivot. When the stand 26 is folded against the back face 30 it fits into a groove 32 so that it is flush with the back face 30. A finger slot 34 is provided so the user can easily pull the stand 26 out.

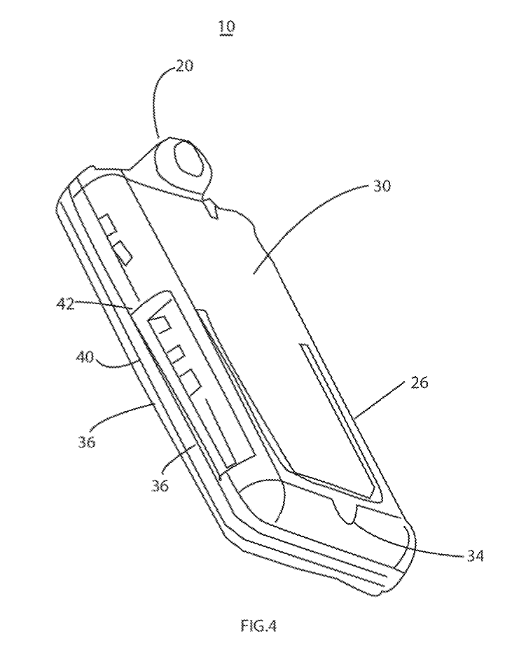

FIG. 4 is a side perspective view of an electronic mirror 10 in accordance with one embodiment of the invention. This view shows that in one embodiment, the electronic mirror 10 includes an SD (Secure Digital) memory card slot 36. A USB (Universal Serial Bus) port 38 is provided. Video input and output ports 40, 42 may also be provided.

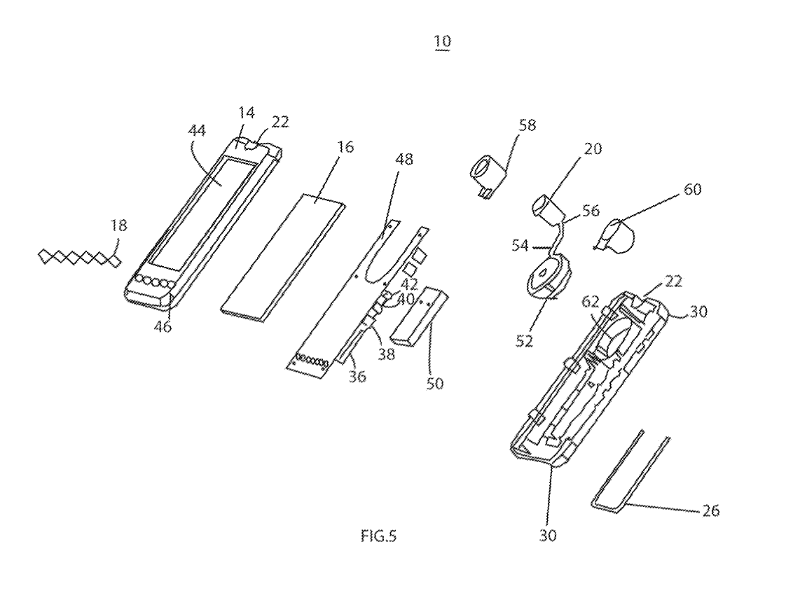

FIG. 5 is an exploded perspective view of an electronic mirror 10 in accordance with one embodiment of the invention. The electronic mirror 10 has a front face 14 that includes an opening 44 for a display 16 and a plurality of holes 46 for buttons 18. The front face 14 has a cutout or slot 22. An electronic circuit board 48 fits inside the housing 12. The electronic circuit 48 may include a processor, a SD memory card slot 36, a USB port 38, and video input and output ports 40, 42. A battery 50 is inside the housing and attaches to the electronic circuit 48. A retraction mechanism 52 is used for retracting an electronic cord 54. A first end of the electronic cord 54 is attached to the retraction mechanism 52 and is in electrical communication with the electronic circuit 48. The second end 56 of the electronic cord 54 is attached to the electronic image sensor 20. The image sensor 20 is encased in a cylindrical housing 58, 60. The back face 30 of the electronic mirror 10 has a circular chamber 62 for holding the retraction mechanism 52. The stand 26 is shown separate from the back face 30.

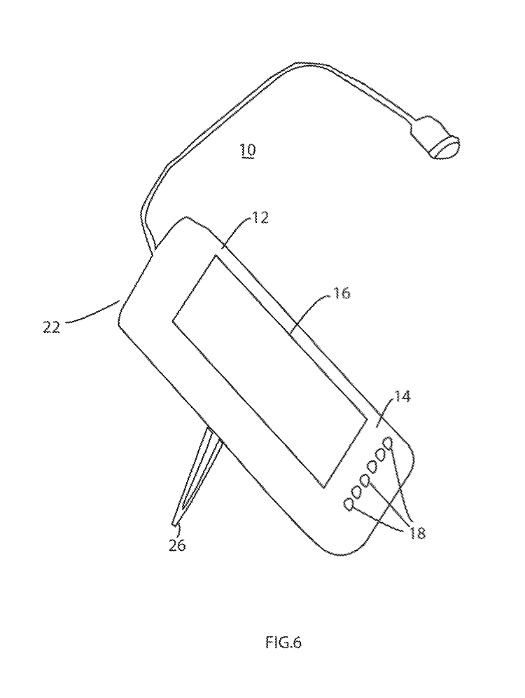

In operation the user turns on the electronic mirror 10 by pushing a button 18 and then pulls the image sensor 20 out of slot 22 as seen in FIG. 6. The user can then move the image sensor around to see the back of their head, top of their head or sides of their head. If they want to freeze the image, they press a button 18 that causes the processor to implement a freeze frame function. The user can also digitally zoom in on the image by pressing a button 18 that causes the processor to implement a digital zoom feature. In one embodiment, the physical lens is a fixed lens. When the user is done with the electronic mirror 10, the retraction mechanism 52 retracts the image sensor back into slot 22. The user can then turn off the mirror or in one embodiment the mirror may turn off after predetermined period of time of no use.

In one embodiment, the electronic mirror 10 may include a digital picture frame functionality. The SD card can hold a number of photos which allows the electronic mirror to then display the photos.

Thus there has been described an electronic mirror that allows the user to check the back of their head and to magnify areas that are hard to see. The electronic mirror is convenient and fits inside a purse or can carried in a pocket by itself.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An electronic mirror capable of being used as a pocket mirror, comprising:
a housing designed to fit in a purse;
an electronic display in the housing;
a processor transmitting an image to the electronic display;
an electronic cord in electrical communication with the processor, the electronic cord have a first end and a second end, the first end attached the housing; and
an electronic image sensor attached to a second end of the electronic cord and capturing the image.

2. The electronic mirror of claim 1, wherein the housing includes a cutout for holding the electronic image sensor.

3. The electronic mirror of claim 1, wherein the electronic image sensor is encased in a cylindrical housing.

4. The electronic mirror of claim 1, wherein the processor includes a freeze frame function.

5. The electronic mirror of claim 4, wherein the housing includes a button and the button activates the freeze frame function.

6. The electronic mirror of claim 1, further including a retraction mechanism holding the electronic cord.

7. The electronic mirror of claim 1, wherein the processor includes a zoom function.

8. An electronic mirror designed to fit in a purse, comprising:
a housing having at least one button;
an electronic screen on a face of the housing;
a processor in electrical communication with the at least one button;
a cord having a first end and a second end, the first end attached to the housing; and
an electronic sensor attached to the second end of the cord.

9. The electronic mirror of claim 8, further including a foldable stand attached to the housing.

10. The electronic mirror of claim 8, wherein the at least one button activates a freeze frame feature of the processor.

11. The electronic mirror of claim 8, wherein the at least one button activates a zoom feature of the processor.

12. The electronic mirror of claim 9, further including a retraction mechanism holding the cord.

13. The electronic mirror of claim 12, further including a slot in the housing for holding the electronic sensor.

14. The electronic mirror of claim 12, further including a battery in the housing.

15. An electronic mirror for personal use, comprising:
an essentially rectangular housing having a front face and a back face;
an electronic display attached to a front face of the housing;
an electronic circuit inside the essentially rectangular housing;
a battery inside the essentially rectangular housing;
a plurality of buttons attached to the front face of the essentially rectangular housing;
an electronic cord having a first end and a second end, the first end attached to the essentially rectangular housing and in electrical communication with the electronic circuit; and
an image sensor attached to a second end of the electronic cord.

16. The electronic mirror of claim 15, further including a stand pivotally attached to a back face of the essentially rectangular housing.

17. The electronic mirror of claim 16, wherein the electronic display is a color display.

18. The electronic mirror of claim 17, wherein one of the plurality of buttons activates a freeze frame feature of the electronic circuit.

19. The electronic mirror of claim 18, wherein one of the plurality of buttons activates a zoom feature of the electronic circuit.

20. The electronic mirror of claim 15, further including a memory card slot, wherein the electronic mirror can display a photo on a memory card.
